(19) United States
(12) Patent Application Publication
(10) Pub. No.: US 2006/0069711 A1
(43) Pub. Date: Mar. 30, 2006

(54) Terminal device and data backup system for the same

(76) Inventors: Taku Tsunekawa, Kawasaki (JP); Hiroshi Sasaki, Kawasaki (JP); Kenichi Namatame, Kawasaki (JP)

Correspondence Address: KATTEN MUCHIN ROSENMAN LLP, 575 MADISON AVENUE, NEW YORK, NY, 10022-2585, US

(21) Appl. No.: 10/996,231

(22) Filed: Nov. 23, 2004

(30) Foreign Application Priority Data
Jul. 8, 2004 (JP) 2004-202265

(51) Int. Cl. G06F 15/16; G06F 12/00

(52) U.S. Cl. 709/200; 711/162

(57) ABSTRACT

The invention relates to data backup of a terminal device and attempts to facilitate data backup by utilizing the existing communication capabilities of backup data storage equipment and the terminal device. Arrangement is such that the terminal device comprises a communication unit connecting to electronic equipment having data storage and communication capabilities by use of the communication unit, and a data processing unit causing the communication unit to transmit data to be stored to the electronic equipment, thereby allowing the electronic equipment to store the data.

### BACKGROUND OF THE INVENTION

1. Field of the Invention

The present invention relates generally to data backup of a terminal device such as a cell phone, and more particularly, to a terminal device using electronic equipment such as a personal computer for data backup, as well as to a data backup system, data backup method and data backup program for the terminal device.

2. Description of the Related Art

Among known methods for backing up data of a terminal device such as a cell phone is for example that the terminal device and electronic equipment such as a personal computer are connected to each other using a short-range wireless communication technique such as Bluetooth, with data to be stored being transmitted from the terminal device to the electronic equipment for the storage therein. Another data backup method stores data of a terminal device in a common carrier's server by connecting the terminal device and the common carrier's server through a network and transmitting the data of the terminal device to the server.

Japanese Patent Application Laid-Open Publication Nos. 2002-112314, 2003-198678, 2003-58286 and H08-182052 are patent documents related to such a storage of terminal device data.

Japanese Patent Application Laid-Open Publication No. 2002-112314 discloses the backup by storing the user data in a TV, PC, router or other fixed storage device in the event of a malfunction, loss, theft, etc. of the terminal device such as a cell phone and a PHS. Japanese Patent Application Laid-Open Publication No. 2003-198678 discloses the backup of some files of a terminal device in a virtual memory by using an external storage device, connected to the terminal device such as a cell phone through wireless communication as the virtual memory. Japanese Patent Application Laid-Open Publication No. 2003-58286 discloses, as a method and system for backing up the data of a wireless device such as a cell phone in a backup server, the data backup in response to a power-up of the wireless device or to a judgment that a given time has elapsed since the last backup. Japanese Patent Application Laid-Open Publication No. H08-182052 discloses the transmission of data such as an address list, schedules or memos accumulated in a wireless terminal to a wireless base station at every user-specified backup time for backup of the data in the wireless base station, thus allowing the wireless terminal side to receive the backup data as necessary.

Incidentally, in relation to the terminal device data backup, using a short-range wireless communication technique such as Bluetooth can save time and effort for cable use and connection. Use of such a technique, however, requires addition of new devices to the terminal device and the equipment on the backup side, resulting in increased device cost, size, weight and so on. Moreover, if the backup data is not updated without intentional data backup operation, a time lag occurs between the terminal device data and the backup data, halving the value of the data backup. Storing the data in a server via a network leads to a communication charge occurring at each backup, making this method problematic in terms of cost efficiency. With the short-range wireless communication techniques, the data transmission distance is short, and in the case of Bluetooth, for example, the communication distance is only roughly 10m, thus limiting the data backup operation of the terminal device to a short distance range. To view the data stored in the electronic equipment with the terminal device, on the other hand, the stored data must be moved to a recording medium or other in advance, thus imposing time and locational restrictions if a recording medium is required to reference the stored data.

This is the reason why easier backup and referencing of a terminal device data is demanded. In relation to such a data backup, the system disclosed in Japanese Patent Application Laid-Open Publication No. 2002-112314, a system provided with storage media in the fixed storage device, does no more than store data therein as an emergency measure in case of malfunction, loss, etc. The system disclosed in Japanese Patent Application Laid-Open Publication No. 2003-198678 is no more than a system using an external storage device connected through wireless communication at a short range, limiting the data backup to a short range. In the data backup method and system described in Japanese Patent Application Laid-Open Publication No. 2003-58286, the data backup of wireless equipment is implemented by connecting the wireless equipment and a server via a wireless network, resulting in a large-scale configuration requiring a backup server and a gateway. The system described in Japanese Patent Application Laid-Open Publication No. H08-182052, on the other hand, is a large-scale system for storing data of a number of wireless terminals through a wireless base station in which the wireless base station and the wireless terminals are wireless-connected, and accumulated data is transmitted at every user-specified time to the wireless base station for storage in RAM. Thus, the conventional data backup methods have been limited to a short distance range, requiring a large-scale system, storage device, etc. for backing up and referencing data and leading to inconveniences including mounting communication cost.

### SUMMARY OF THE INVENTION

The present invention relates to data backup of a terminal device, and it is an object of the present invention to facilitate data backup by employing the existing communication capabilities of backup data storage equipment and the terminal device.

The present invention implements data backup of a terminal device using the communication capability of the terminal device. In the present invention, therefore, the terminal device and the storage equipment for storing backup data are connected to each other, with data of the terminal device being transmitted to the storage equipment for storage through use of the communication capabilities of the two so that the data is read out from storage equipment for access. The configuration of the present invention is as follows:

In order to achieve the above object, according to an aspect of the present invention there is provided a terminal device comprising a communication unit connecting to electronic equipment having data storage and communication capabilities by use of the communication unit; and a data processing unit causing the communication unit to transmit data to be stored to the electronic equipment, thereby allowing the electronic equipment to store the data. In this terminal device, the communication unit and the data processing unit are provided in the terminal device, with the communication unit connecting to the electronic equipment—equipment on the data storage side—using the communication capability of the electronic equipment. Then, the data processing unit transmits data accumulated in the terminal device to the electronic equipment through the communication unit, with the transmitted data being stored using the data storage capability of the electronic equipment. This data can be accessed on the terminal equipment as the data is read out from the electronic equipment.

To attain the above object, at a given time interval the data processing unit may monitor broadcast information transmitted from the electronic equipment. That is, if the cell phone has the discontinuous reception capability as a communication capability, one has only to use this discontinuous reception capability. This capability allows broadcast information transmitted from the electronic equipment to be monitored at a given time interval. Thus, monitoring of the broadcast information from the electronic equipment at a given time interval keeps data backup opportunities intact, making this method rational given the nature of data backup storing accumulated data and allowing power saving as compared with continuous monitoring.

In this terminal device, the data processing unit may cause the data to be stored to be transmitted to the electronic equipment based on identification of specific electronic equipment; the electronic equipment may periodically transmit broadcast information; and in cases where the electronic equipment stores data of the terminal device, the electronic equipment may halt transmission of broadcast information until a given time elapses from the storage of the data.

In order to achieve the above object, according to another aspect of the present invention there is provided a data backup system for a terminal device, arranged to back up data accumulated in the terminal device, comprising electronic equipment having data storage and communication capabilities; and the terminal device including a communication unit connecting for communication to the electronic equipment by use of the communication capability and a data processing unit causing the communication unit to transmit data to be stored, thereby allowing the electronic equipment to store the data. In this data backup system, the electronic equipment is provided with the data storage and communication capabilities, achieving connection between the two through use of the communication capabilities of the communication unit in the terminal device and of the electronic equipment. Data accumulated in the terminal device is transferred through the communication unit to the electronic equipment by the data processing unit and stored using the data storage capability of the electronic equipment.

The data processing unit may cause the data to be stored to be transmitted to the electronic equipment based on identification of specific electronic equipment; the electronic equipment may periodically transmit broadcast information; and in cases where the electronic equipment stores the data of the terminal device, the electronic equipment may halt transmission of broadcast information until a given time elapses from completing the storage of the data.

In order to achieve the above object, according to a further aspect of the present invention there is provided a data backup method for a terminal device that backs up data accumulated in the terminal device, comprising a communication process of connecting for communication to electronic equipment having data storage and communication capabilities using the communication unit; and a data processing of causing data to be stored to be transmitted. This achieves facilitation of data backup of the terminal device.

The data processing may include a processing of causing the data to be stored to be transmitted to the electronic equipment based on identification of specific electronic equipment; the method may further comprise a processing of periodically transmitting broadcast information from the electronic equipment; and the method may further comprise a processing of halting transmission of broadcast information, in cases where the data of the terminal device is stored in the electronic equipment, until a given time elapses from completing the storage of the data.

In order to achieve the above object, according to still another aspect of the present invention there is provided a data backup program for a terminal device that backs up data accumulated in the terminal device, comprising the steps of causing the terminal device to connect to electronic equipment having data storage and communication capabilities by use of the communication unit; and causing the terminal device to transmit data to be stored to the connected electronic equipment. This also achieves facilitation of data backup of the terminal device.

The data backup program for a terminal device of the present invention may further comprise the step of periodically transmitting broadcast information from the electronic equipment.

In order to achieve the above object, according to yet another aspect of the present invention there is provided a data backup program for a terminal device that backs up data accumulated in the terminal device, comprising the steps of identifying the terminal device based on specific information registered in advance in electronic equipment where the data is to be stored; and causing data transferred from the identified terminal device to be stored at a data storage location of the electronic equipment.

The data storage may include the step of causing the data to be stored to be transmitted to the electronic equipment based on identification of specific electronic equipment; and the data backup program may further comprise the step of halting transmission of broadcast information, in cases where the data of the terminal device is stored, until a given time elapses from completing the storage of the data.

As set forth hereinabove, the present invention offers automatic transfer and backup of various data including phone book data accumulated in the terminal device from the terminal device to the electronic equipment through direct connection between the terminal device and the electronic equipment by using the radio wave employed for the terminal device, facilitating the data backup of the terminal device and ensuring enhanced convenience and thereby making the invention industrially useful.

Features and advantages of the present invention are:

(1) The terminal device data is transferred and stored in the electronic equipment by connecting the terminal device accumulating data to the electronic equipment equipped with the data storage and communication capabilities using the communication unit, allowing storage and backup of the terminal device data in the electronic equipment by using the existing capabilities of the terminal device accumulating data and the electronic equipment storing data and eliminating the need to add devices.

(2) The terminal device data is transferred and stored in the electronic equipment by connecting the terminal device accumulating data to the electronic equipment equipped with the data storage and communication capabilities using the communication unit, allowing updating to the latest data and automating data backup including periodical backup.

(3) Data transfer is carried out through direct connection of the electronic equipment and the terminal device by using the communication capability of the electronic equipment storing data and establishing connection between the electronic equipment and the terminal device, requiring no involvement of a charging system between the two and ensuring economy.

(4) Connection is established between the terminal device and the electronic equipment using the communication capability of the electronic equipment storing data, enhancing flexibility in the backup processing even in the case of a distance of approximately several km between the two.

(5) The data backed up by the electronic equipment can be referenced as desired on the terminal device by connecting to the terminal device using the communication capability of the electronic equipment, securing the date storage to enhance the reliability thereof.

### BRIEF DESCRIPTION OF THE DRAWINGS

The above and other objects, aspects, features and advantages of the present invention will become more apparent from the following description of the embodiment when taken in conjunction with the accompanying drawings, in which:

FIG. 1 shows a configuration of a data backup system for a terminal device according to an embodiment of the present invention;

FIG. 2 is a block diagram showing a configuration of a cell phone according to the embodiment of the present invention;

FIG. 3 is a block diagram showing a configuration of electronic equipment;

FIG. 4 is a block diagram showing an example of form of connection between the electronic equipment and the cell phone;

FIG. 5 shows an example of form of operation of the electronic equipment or the cell phone;

FIG. 6 is a flowchart showing the connection and data backup processes between the electronic equipment and the cell phone;

FIGS. 7A, 7B, 7C and 7D show the connection and data backup processes between the electronic equipment and the cell phone;

FIG. 8 is a flowchart showing the connection and data backup processes between the electronic equipment and the cell phone;

FIG. 9 is a flowchart showing the connection processing between the electronic equipment and the cell phone and the backup data readout processing from the electronic equipment;

FIG. 10 is a flowchart showing the communication control and data backup processes with the cell phone as viewed from the electronic equipment side;

FIG. 11 is a flowchart showing the communication control and data backup processes with the cell phone as viewed from the electronic equipment side;

FIG. 12 is a flowchart showing the communication control and data backup processes with the electronic equipment as viewed from the cell phone side; and

FIG. 13 is a flowchart showing the communication control and data backup processes with the electronic equipment as viewed from the cell phone side.

### DETAILED DESCRIPTION OF THE PREFERRED EMBODIMENTS

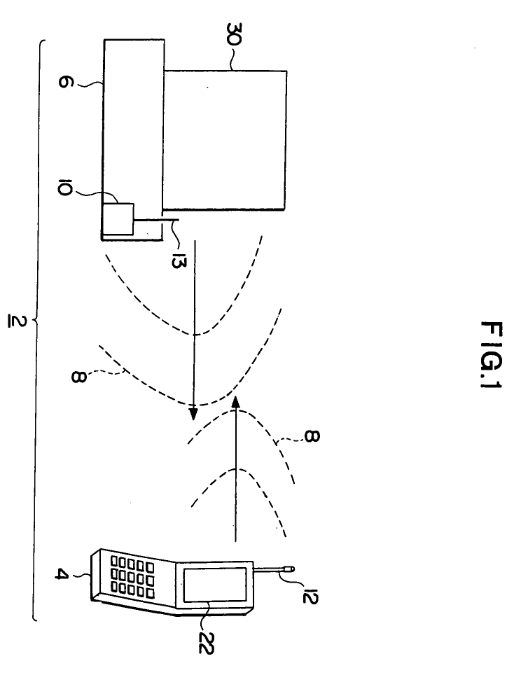

Description will be given of an embodiment of the present invention with reference to FIG. 1. FIG. 1 is a view showing a configuration of a data backup system according to the present invention.

A data backup system 2 is provided, together with a cell phone 4, for example, as a terminal device (mobile station), with electronic equipment 6 as associated equipment of the cell phone 4. The electronic equipment 6 may be any one of a personal computer, PDA (Personal Digital Assistant), TV, camera, gaming machine and others. The cell phone 4 and the electronic equipment 6 are directly connected using, for example, a radio wave 8 in the mobile communications band so that the data of the cell phone 4 to be backed up is transferred from the cell phone 4 to the electronic equipment 6 for storage, and the stored data is transferred to the cell phone 4 as necessary for access, thus enhancing ease and convenience of data backup of the cell phone 4. In the data backup system 2 in such an embodiment, the direct connection between the cell phone 4 and the electronic equipment 6 with the radio wave 8 means a direct communication between the two with only the radio wave 8 involved between the cell phone 4 and the electronic equipment 6 and without any involvement of a third party such as a network, base station or wireless server. The cell phone 4 is equipped with the communication capability in addition to the phone capability, with the communication capability using, for example, a W-CDMA (Wideband-Code Division Multiple Access) communication system. On the other hand, the electronic equipment 6, one of a variety of information processing devices such as a personal computer, is equipped, for example, with a cell phone communication module 10 as a configuration allowing data exchange with the cell phone 4. The cell phone communication module 10 has a communication capability compatible with that of the cell phone 4, associated equipment, when the communication capability incorporated in the cell phone 4 uses a W-CDMA communication system. The cell phone communication module 10 may be built into the electronic equipment 6 or installed so as to be detachable and has an antenna 13 compatible with an antenna 12 of the cell phone 4.

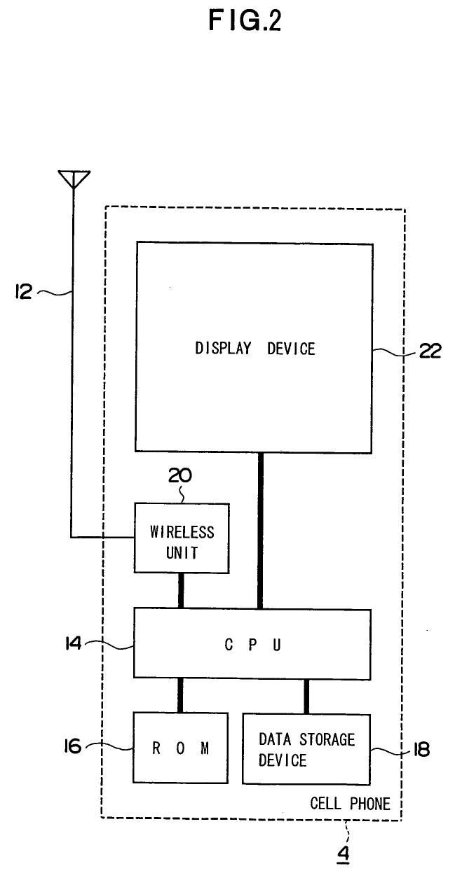

Description will be given next of the terminal device according to the present invention with reference to FIG. 2. FIG. 2 is a block diagram showing a configuration of a cell phone, an example of the terminal device according to the present invention.

The cell phone 4 is provided with a CPU (Central Processing Unit) 14, a ROM (Read-Only Memory) 16, a data storage device 18, a wireless unit 20, a display device 22 and so on as hardware. The CPU 14 makes up a data processing unit for processing various programs including a communication control program. The ROM 16 stores the programs such as the communication control program for establishing communication connection with the electronic equipment 6 and a data backup program for storing accumulated data to other equipment. In this case, the communication control program includes a program for transmitting the backup data to the electronic equipment 6. The data storage device 18, made up, for example, of a flash memory, stores various data including received data, and the data to be stored includes phone book data. Handling data transmission and reception using the radio wave 8, the wireless unit 20, a communication unit in charge of transmission and reception of data such as backup data, is provided with a baseband unit, an RF (Radio Frequency) unit, etc. and connected to the antenna 12. On the other hand, the display device 22 comprises, for example, an LCD (Liquid Crystal Display) and is used to display the contents of received data and others.

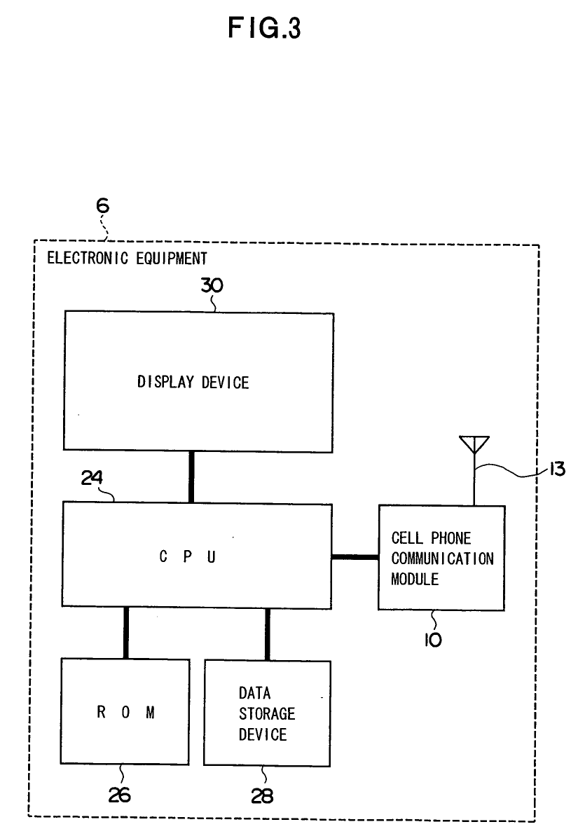

Description will be given next of the electronic equipment used in the data backup system of the terminal device according to the present invention with reference to FIG. 3. FIG. 3 is a block diagram showing an example of the electronic equipment.

The electronic equipment 6, made up, for example, of a personal computer, is provided with a CPU 24, a ROM 26, a data storage device 28, a display device 30 and so on as hardware together with the cell phone communication module 10. The cell phone communication module 10, a module provided with the baseband, RF and other units as with the cell phone 4 or the cell phone base station, is a functional unit handling communication with the cell phone 4 using the radio wave 8. The CPU 24 makes up the data processing unit for processing the programs such as the communication control program. The ROM 26 stores the programs including the communication control program and a data processing program for designating the backup data storage location and identification information specific to the terminal device. The data storage device 28, made up, for example, of an HDD (Hard Disk Drive), stores various data including received data, and the data to be stored includes phone book data transferred from the cell phone 4 mentioned earlier. On the other hand, the display device 30 is made up, for example, of an LCD and used to display the contents of received data and others.

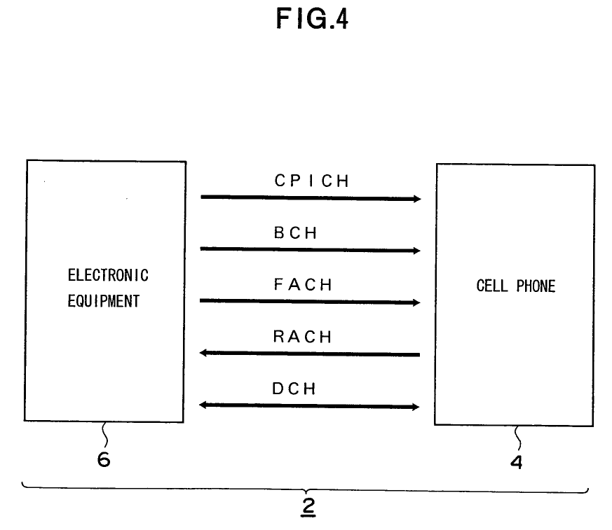

Description will be given next of the correspondence relationship between the electronic equipment and the terminal device in communication connection with reference to FIG. 4. FIG. 4 shows the correspondence between the electronic equipment and the terminal device in communication connection.

Data transfer between the electronic equipment 6 and the cell phone 4, carried out by the W-CDMA communication system mentioned earlier, employs channels including CPICH (Common Pilot Channel), DCH (Dedicated Channel), BCH (Broadcast Channel), FACH (Forward Access Channel) and RACH (Random Access Channel). CPICH, a physical channel, is an information signal designed to ensure direct synchronization between the electronic equipment 6 and the cell phone 4. DCH, BCH, FACH and RACH are transport channels. The transport channels are provided with a capability to associate data rate information of various data or logical channel information of channels having different transfer types with physical channels. Of the transport channels, DCH is a dedicated channel assigned to a mobile station for user data transfer, BCH a downlink broadcast channel for transfer of system information and other, and FACH a downlink common channel used for transfer of control information and user data, that is shared by a plurality of mobile stations and primarily employed for low-rate data transfer. On the other hand, RACH is an uplink common channel used for transfer of control information and user data and employed for low-rate data transfer for random access irrespective of other communications.

The present data backup system, the data backup method and the data backup program thereof, for this reason, use a CPIH to notify channel estimation/synchronization information and a BCH to notify specific identification information such as the password of the electronic equipment 6, carrying out these notifications from the electronic equipment 6 to the cell phone 4 automatically and periodically, periodically monitoring these pieces of information at the cell phone 4, authenticating the electronic equipment 6 after assessing the contents of received information, and transmitting the broadcast information of the cell phone 4 to the electronic equipment 6. The present data backup system, the data backup method and the data backup program thereof employ a RACH to transmit broadcast information of the cell phone 4, a FACH/RACH to handle connection between the cell phone 4 and the electronic equipment 6, a DCH to issue a data transmission request from the electronic equipment 6 to the cell phone 4, and a DCH to transmit backup data from the cell phone 4 to the electronic equipment 6.

The data backup system 2 enables automatic storage of the data in the cell phone 4, and in this case, CPICH and BCH—CPICH for channel estimation/synchronization and BCH as the broadcast information including identification information—are transmitted from the electronic equipment 6 using a radio wave in the mobile communications band such as a W-CDMA system radio wave. The broadcast information includes IMEI (International Mobile Equipment Identity) and specific identification information such as the password, and IMEI is information for identifying the cell phone 4 or the electronic equipment 6. Periodically monitoring a CPICH, the corresponding cell phone 4 receives a BCH as the broadcast information from the electronic equipment 6 and loads identification information following the CPICH reception and synchronization, compares the identification information with that stored in advance in the cell phone 4 and authenticates the electronic equipment 6 as being the specific electronic equipment 6 that has been registered.

At the completion of the authentication processing, the cell phone 4 transmits a RACH with attached identification information to the electronic equipment 6. In response, the electronic equipment 6 receives the RACH, compares the RACH with the identification information of the cell phone 4 registered in advance in the electronic equipment 6, authenticates the cell phone 4 as being the specific the cell phone 4 that has been registered, and establishes connection between each other using a FACH/RACH. That is, a condition is established in which data exchange is possible. Then, the electronic equipment 6 requests, as a result of establishment of a DCH link, the transmission of data such as phone book data, set by special-purpose application software, to the cell phone 4.

The cell phone 4 opens the DCH and transmits, for example, the phone book data to the electronic equipment 6 as requested data. After the data transmission and storage of the data, the cell phone 4 transmits a message indicating completion of the data storage and cuts off the DCH connection. This completes the backup of data to be stored on the side of the cell phone 4.

To call the stored data into the cell phone 4 from the electronic equipment 6, on the other hand, a RACH containing identification and other information of the cell phone 4 is transmitted from the cell phone 4. The electronic equipment 6 receives the RACH and performs an authentication processing for comparing the RACH with the identification information of the cell phone 4 registered in advance, thus establishing connection between the two using the already-described FACH/RACH. That is, the electronic equipment 6 establishes a DCH link and requests the cell phone 4 to transmit, for example, the phone book data to the electronic equipment 6 as requested data. After the data transmission, the electronic equipment 6 cuts off the DCH connection.

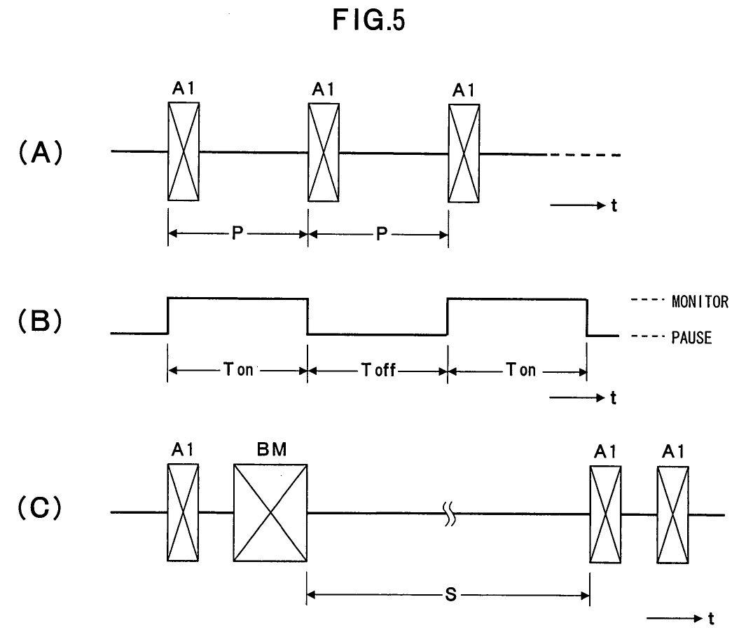

Reference will then be made to FIG. 5 to describe the data backup system, data backup method and data backup program according to the present invention. FIG. 5 is a view showing timings of the broadcast information and the processes of the broadcast information such as recognition and backup.

As shown in (A) of FIG. 5, broadcast information AI containing identification information ID—information required for the authentication that is a precondition for the data backup processing—is transmitted at a constant interval P in advance as the processing of the electronic equipment 6 by running the special-purpose application software on the side of the electronic equipment 6. The broadcast information AI includes the identification information ID such as the password and IMEI as described earlier. The interval P at which the broadcast information AI is transmitted is, for example, one minute or so.

On the other hand, the cell phone 4 periodically monitors, for example, the broadcast information AI arriving from the electronic equipment 6 as shown in (B) of FIG. 5, with Tₒₙ representing a monitoring time in the monitoring state and T_{off} representing a pause time of the monitoring state. The broadcast information AI can be recognized in the monitoring time Tₒₙ. The monitoring time Tₒₙ may or may not match the interval P of the broadcast information AI on the side of the electronic equipment 6.

When the broadcast information AI is recognized by the cell phone 4, a data backup processing BM is executed, for example, as shown in (C) in FIG. 5. In the data backup processing BM, the data of the cell phone 4 is stored in the electronic equipment 6. At the completion of the data backup processing BM, a pause time S is set in a time period from the moment of completion of the data backup processing BM to the first transmission of the broadcast information AI. In the pause time S, the transmission of the broadcast information AI is halted irrespective of arrival of the monitoring time Tₒₙ, and therefore the data backup processing BM is not executed. The pause time S is, for example, six hours or so.

Thus, periodical monitoring of the broadcast information AI on the side of the cell phone 4 expands connection opportunities between the electronic equipment 6 and the cell phone 4 and allows a fast data backup processing, preventing repetitions of the data backup thanks to settings of the monitoring pause time T_{off} and the post-data-backup pause time S and suppressing power consumption of the cell phone 4 and the electronic equipment 6. Battery exhaustion can be suppressed if batteries are used as a power source.

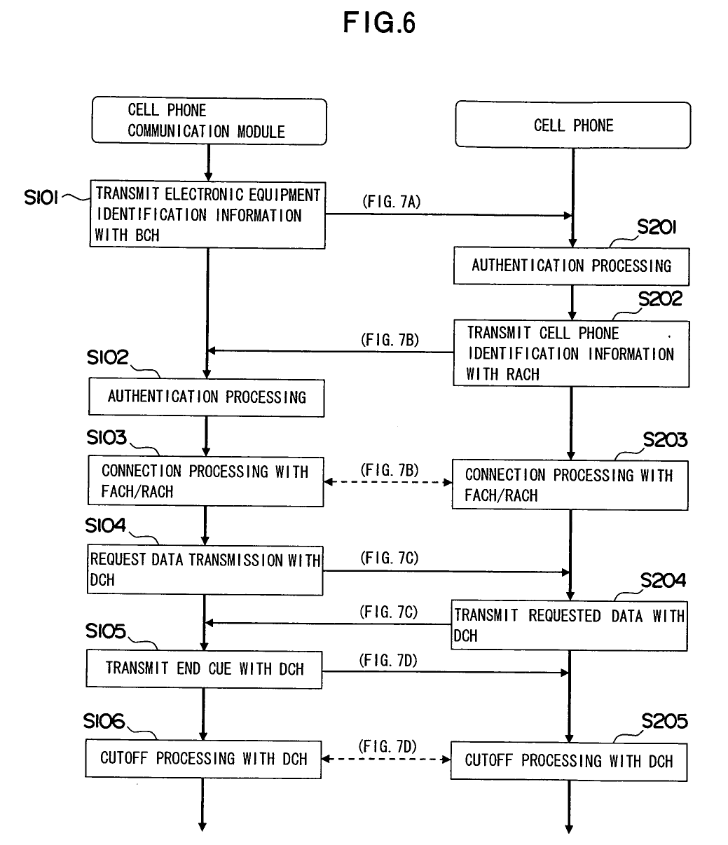

Description will be given next of the data backup system according to the present invention, the data backup method thereof and the data backup program thereof with reference to FIG. 6. FIG. 6 is a view showing the automatic storage processing of the cell phone data to the electronic equipment. The automatic storage processing is a data backup processing based on the automatic processing on the side of the electronic equipment.

In the data backup processing, phone book data, received email data and other data is selected, for example, as the data to be backed up from among various data of the cell phone 4. A backup data storage location is registered in advance in the electronic equipment 6. For data communication between the electronic equipment 6 and the cell phone 4, a W-CDMA communication system radio wave is used, for example, as the communication system of the cell phone 4.

The initial setup is performed by running the special-purpose application software installed in the electronic equipment 6 in advance by the user, and the details of the setup are various entries including the passwords of the electronic equipment 6 and the cell phone 4 for authentication, the type (and contents) of the cell phone 4 data to be backed up, the transmission interval P of CPICH/BCH (AI), the pause time S and the storage location of the backup data.

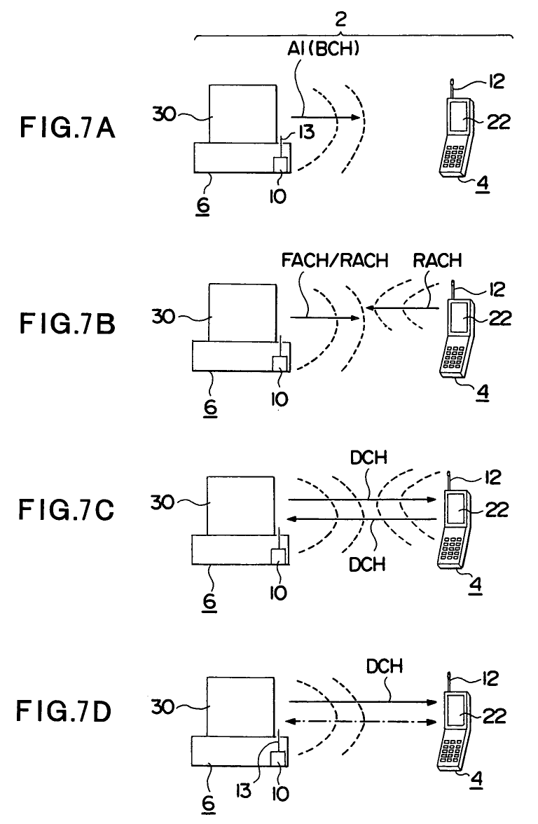

Then, when such a data setup is complete, the cell phone communication module 10 in the electronic equipment 6 transmits, on condition of power-up, etc., a BCH containing the already-described CPICH for channel estimation/synchronization and the broadcast information AI of the electronic equipment 6 (step S101). The broadcast information AI, transmitted at a constant interval from the electronic equipment 6 as described above, contains the identification information ID (FIGS. 5A and 7A).

The cell phone 4 monitors the arrival of the broadcast information AI during the monitoring time Tₒₙ and, when detecting the radio wave 8 transmitted from the electronic equipment 6, proceeds with the authentication processing including determining whether the radio wave 8 belongs to the electronic equipment 6, assessing the contents and making a comparison with the identification information ID registered in advance (step S201). When, as a result of the authentication processing, the electronic equipment 6 is recognized as being the registered electronic equipment 6 by the cell phone 4, the cell phone 4 transmits the identification information ID to the electronic equipment 6 with a RACH (step S202, FIG. 7B).

When receiving the radio wave 8 from the cell phone 4, the cell phone communication module 10 of the electronic equipment 6 proceeds with the authentication processing of the cell phone 4 using the received identification information ID (step S102) and, when the cell phone 4 is found to be the cell phone 4 registered in advance, establishes connection with the cell phone 4. That is, the connection processing is performed by the both parties using a FACH/RACH (steps S103 and S203, FIG. 7B), with the data backup processing executed under the processing conditions set in advance.

In the data backup processing, the cell phone communication module 10 of the electronic equipment 6 requests the transmission of the data to be stored to the cell phone 4 with a DCH (step S104, FIG. 7C). In response to the request, the cell phone 4 transmits the data to the electronic equipment 6 with a DCH (step S204, FIG. 7C). At the completion of the data reception, the cell phone communication module 10 transmits end information to the cell phone 4 with a DCH as a cue indicating the end of the data reception (step S105, FIG. 7D). This completes the data backup.

Following the backup processing, the cutoff processing of the communication connection is executed using a DCH (steps S106 and S205, FIG. 7D), after which the cell phone 4 and the electronic equipment 6 will remain on standby until the next data backup processing. This standby time corresponds to the pause time S (FIG. 5C).

Incidentally, in relation to the periodic transmission of the broadcast information AI from the electronic equipment 6 and the response of the cell phone 4 to the transmission in the data backup processing, while CPICH for channel estimation/synchronization and BCH as the broadcast information are transmitted from the electronic equipment 6, both the cell phone 4 and the electronic equipment 6 must be in the receivable area of the radio wave as long as the radio wave is used as a data transfer medium. That is, when entering the receivable range of the CPICH transmitted from the electronic equipment 6, the cell phone 4 can receive a BCH after receiving the CPICH and achieving synchronization. As a result, the authentication processing of the electronic equipment 6 is performed based on the contents of the BCH. In other words, connection between the two is established when the cell phone 4 detects the radio wave 8 transmitted by the electronic equipment 6 and recognizes the radio wave 8 as being the radio wave transmitted from the electronic equipment 6, with this connection conducted automatically. Once connection is established, the data backup processing is performed automatically. This allows a connection request to be made from the cell phone 4 to the electronic equipment 6 and access to the data in the electronic equipment 6 on the cell phone 4—processes that will be described later.

On the side of the cell phone 4, authentication of the electronic equipment 6, connection and transmission and storage of the backup data are carried out, with the data specified in the initial setup such as phone book data and mail data stored in a given storage location of the electronic equipment 6—at a given address of the data storage device 28 such as a HDD. Then, at the completion of the storage end notice, the cutoff processing. (DCH) is carried out, resulting in a transition to the pause time S (FIG. 5C). The pause time S is set to a desired length in the initial setup, and the operation of the cell phone communication module 10 is halted during this time period, with the startup of the cell phone communication module 10 inhibited. Then, when the pause time S elapses, the cell phone communication module 10 is restored to the initial state periodically transmitting a CPICH/BCH. It is to be noted that the pause may be canceled at a desired time upon a user request.

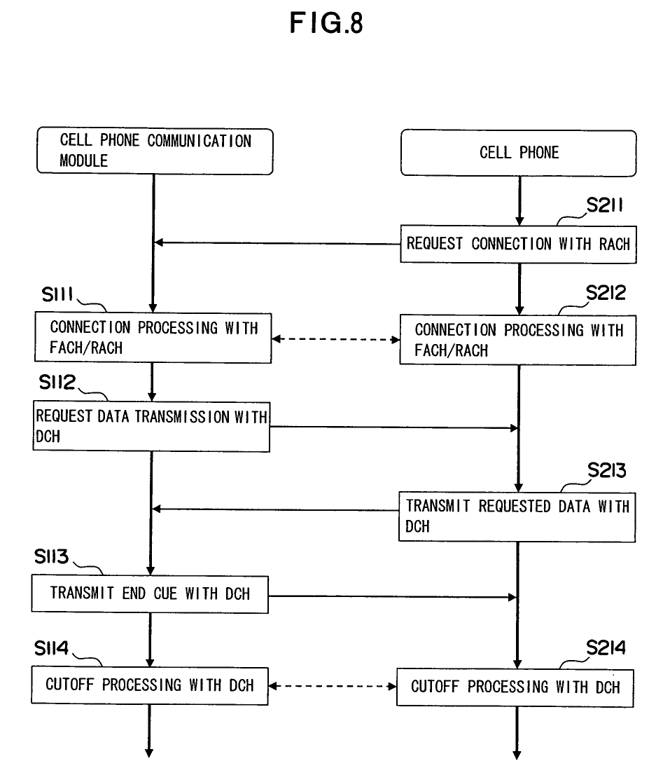

Description will be given next of the data backup system according to the present invention, the data backup method thereof and the data backup program thereof with reference to FIG. 8. FIG. 8 is a flowchart showing the data storage processing by a request from the cell phone.

Following the already-described authentication processing (FIG. 6), the cell phone 4 makes a connection request with a RACH (step S211). Upon receiving the radio wave 8 from the cell phone 4, the cell phone communication module 10 proceeds with the authentication processing of the cell phone 4 with the identification information ID contained in the RACH, and when the cell phone 4 is found to be the cell phone 4 registered in advance, both the cell phone 4 and the cell phone communication module 10 proceed with the connection processing using a FACH/RACH (steps S111 and S212).

Once this connection is established, the cell phone communication module 10 requests the transmission of the data to be stored to the cell phone 4 with a DCH (step S112), and in response to the request, the cell phone 4 transmits the data to the electronic equipment 6 with a DCH (step S213). At the completion of the data reception, the cell phone communication module 10 transmits end information to the cell phone 4 with a DCH as a cue indicating the end of the data reception (step S113). This completes the data backup.

Following the backup processing, the cutoff processing of the communication connection is executed using a DCH (steps S114 and S214), after which the cell phone 4 and the electronic equipment 6 will similarly remain on standby until the next data backup processing.

Thus, in response to the data backup request from the cell phone 4, the backup processing is performed of the data of the cell phone 4 as with the automatic backup processing from the electronic equipment 6. In this case, while the data backup request from the cell phone 4 can be made as desired through the user operation of the cell phone 4, a transition to the pause time S takes place similarly after the data backup processing, and when the pause time S elapses, the already-described data backup processing is carried out.

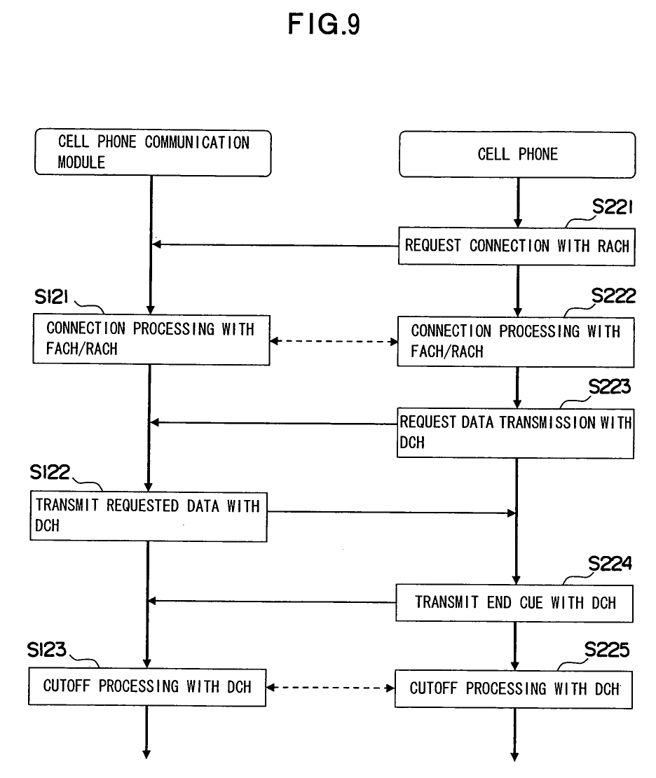

Description will be given next of the data backup system according to the present invention, the data backup method thereof and the data backup program thereof with reference to FIG. 9. FIG. 9 is a flowchart showing the call processing of the data stored in the electronic equipment.

This data transfer processing is executed based on a call request from the cell phone 4. Following the already-described authentication processing (FIG. 6), the cell phone 4 makes a connection request with a RACH (step S221). Upon receiving the radio wave 8 from the cell phone 4, the cell phone communication module 10 proceeds with the authentication processing of the cell phone 4 with the identification information ID contained in the RACH, and when the cell phone 4 is found to be the cell phone 4 registered in advance, both the cell phone 4 and the cell phone communication module 10 proceed with the connection processing using a FACH/RACH (steps S121 and S222).

Once this connection is established, the cell phone 4 requests the transmission of the data to be transferred to the cell phone communication module 10 with a DCH (step S223), and in response to the request, the cell phone communication module 10 transmits the data to the cell phone 4 with a DCH (step S122). At the completion of the data reception, the cell phone 4 transmits end information to the cell phone communication module 10 with a DCH as a cue indicating the end of the data reception (step S224). This completes the data transfer.

Following the transfer processing, the cutoff processing of the communication connection is executed using a DCH (steps S123 and S225). Then, the cell phone 4 can, for example, restore the lost or once-existing phone book data or mail data and proceed with the same data processing as before by using the data transferred from the cell phone communication module 10.

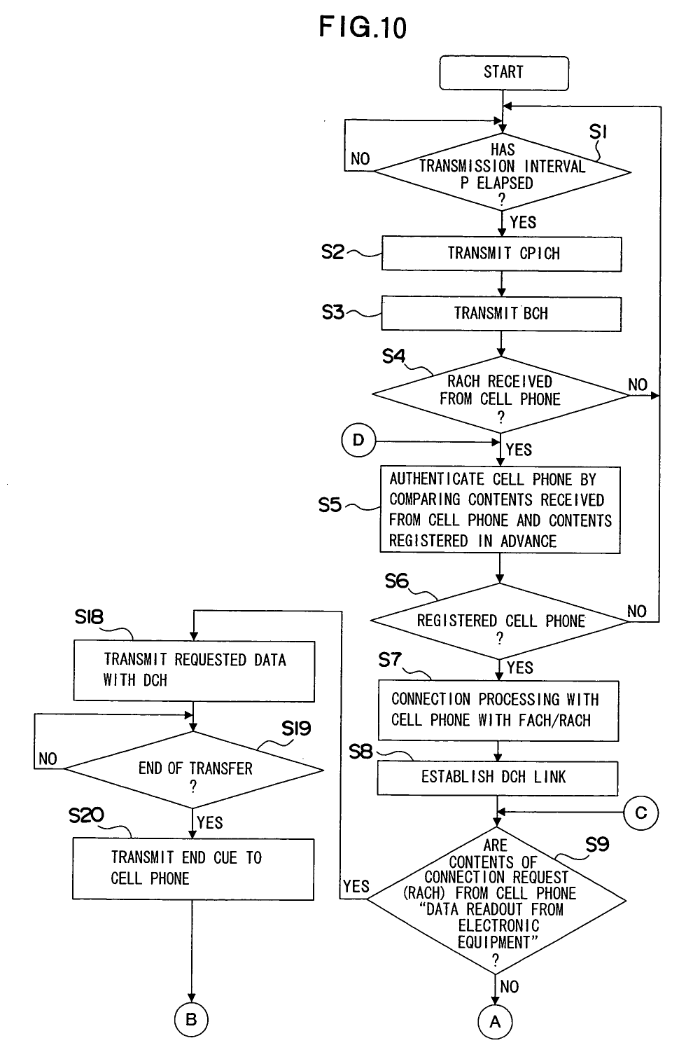

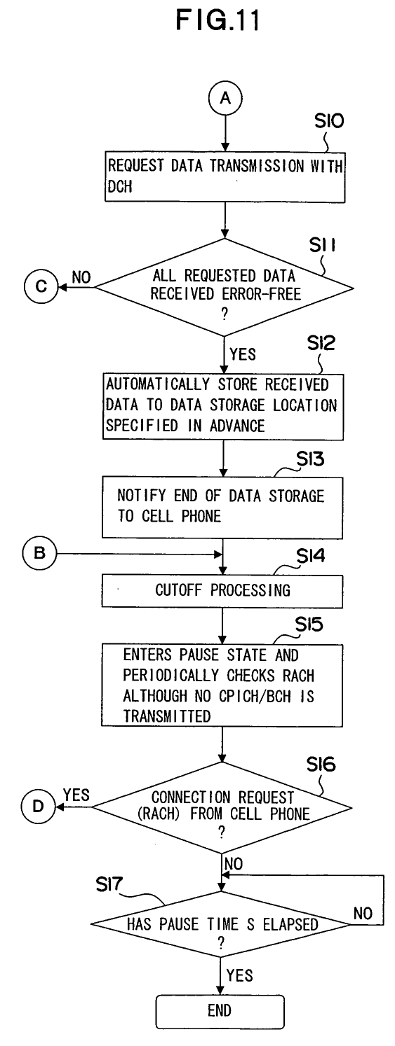

Description will be given next of the data backup system according to the present invention, the data backup method thereof and the data backup program thereof with reference to FIGS. 10 and 11. FIGS. 10 and 11 are a flowchart showing the connection and data transfer processes with the cell phone as viewed from the electronic equipment side. In FIGS. 10 and 11, A, B, C and D represent flowchart connectors.

This series of processes is designed to back up the data of the cell phone 4 with the cell phone communication module 10 of the electronic equipment 6. In the processes, the cell phone communication module 10 judges whether the transmission interval P has elapsed (step S1), transmits a CPICH (step S2) and transmits a BCH (step S3) in order to periodically transmit the broadcast information AI. As described already, the BCH is the broadcast information AI containing the identification information ID specified by the special-purpose application software for the cell phone communication module 10 of the electronic equipment 6, with IMEI and the passwords included in the identification information ID. A RACH is transmitted from the cell phone 4 that has received the BCH, and the electronic equipment 6 judges whether the RACH has been received (step S4). When the RACH has been received, the electronic equipment 6 proceeds with the authentication processing of the cell phone 4 including comparing the contents received from the cell phone 4 and the contents registered in advance (step S5)

In the authentication processing, the electronic equipment 6 judges whether the cell phone 4 is the cell phone 4 that has been registered (step S6) and, when the cell phone 4 is the registered cell phone 4, proceeds with the connection processing with the cell phone 4 using a FACH/RACH (step S7), thus establishing a DCH link (step S8). After the establishment of the connection, the electronic equipment 6 judges whether the contents of the connection request (RACH) from the cell phone 4 are data readout from the electronic equipment 6 (step 9) and, when the contents of the connection request are not data readout from the electronic equipment 6, transmits a DCH., thus requesting the transmission of data to the cell phone 4 (step S10). As for the data requested to be transmitted, the data type, area and other information are set in advance with the special-purpose application software as described above.

The electronic equipment 6 judges whether the data transmitted from the cell phone 4, i.e., the data requested from the electronic equipment 6 has been all received error-free (step S11) and, in the case of error-free reception, stores the received data to the storage location of the data storage device 28 specified in advance (step S12) and, following the storage processing, notifies the end of data storage to the cell phone 4 (step S13). In the case of imperfect data reception, on the other hand, the electronic equipment 6 returns to step S9, requesting the retransmission of the requested data and executing the processes from steps S9 to S12 until perfect data reception is complete. After notifying the end of data storage, the electronic equipment 6 proceeds with the cutoff processing (step S14) first and then transitions to the pause state, halting the transmission of a CPICH/BCH (step S15). In this case, the electronic equipment 6 periodically checks for the RACH even while in the pause state. Therefore, the electronic equipment 6 judges whether a connection request (RACH) is made from the cell phone 4 (step S16) and, in the presence of a connection request, cancels the pause state, executing the processes from step S5 onward as the data backup processing. In the absence of a connection request, the electronic equipment 6 maintains the pause state until the pause time S elapses (step S17) and is restored to the initial state by terminating a series of processes after the pause time S elapses, thus causing the processes from step S1 onward to be repeated.

On the other hand, if, in step S9, the contents of the connection request (RACH) from the cell phone 4 are data readout from the electronic equipment 6, the electronic equipment 6 transmits the data requested by the cell phone 4 with a DCH (step S18). The transmission state is maintained until the data transmission with a DCH is complete (step S19), and following the data transmission, the electronic equipment 6 transmits an end cue to the cell phone 4 (step S20) and then moves to step S14, executing the cutoff processing.

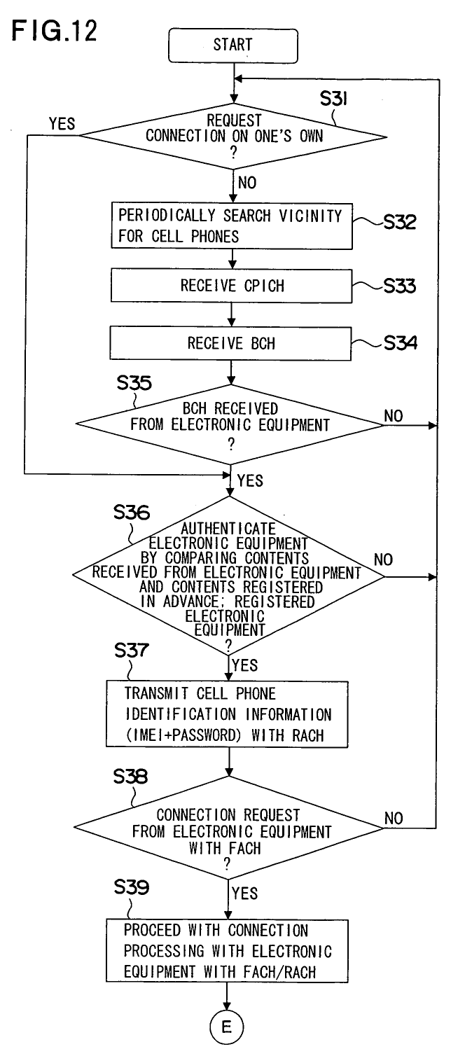

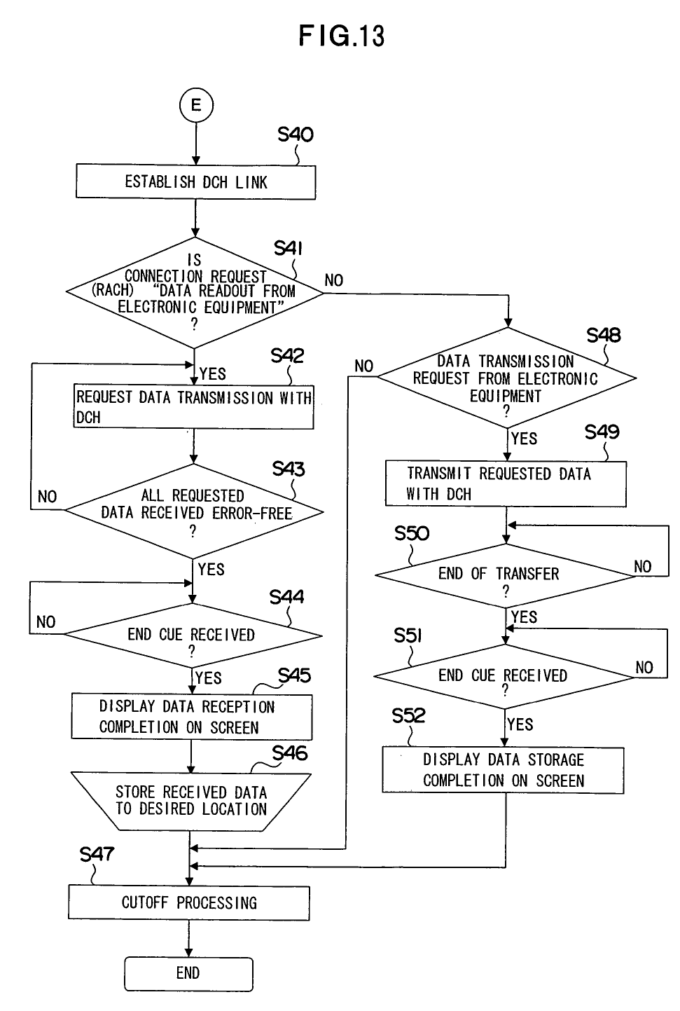

Description will be given next of the data backup system according to the present invention, the data backup method thereof and the data backup program thereof with reference to FIGS. 12 and 13. FIGS. 12 and 13 are a flowchart showing the connection and data transfer processes with the electronic equipment as viewed from the cell phone side. In FIGS. 12 and 13, E represents a flowchart connector.

In the present processing, the cell phone 4 judges whether to request connection to the cell phone communication module 10 of the electronic equipment 6 (step S31). In this case, the connection request includes, as the contents, either storage of the data of the cell phone 4 or readout of the data from the electronic equipment 6. If no connection request is made, the cell phone 4, as the normal operation, periodically searches the vicinity for the electronic equipment 6 and other cell phones (step S32), receives a CPICH (step S33) and receives a BCH (step S34), judging whether the received BCH is a BCH from the electronic equipment 6, an associated device (step S35). If the BCH is not from the electronic equipment 6, the cell phone 4 returns to step S31. When the BCH is from the electronic equipment 6, the cell phone 4 proceeds with the authentication processing of the electronic equipment 6 including comparing the contents received with the contents registered in advance, thus judging whether the electronic equipment 6 is the electronic equipment 6 that has been registered (step S36) In this case, if a connection request is made in step S31, the cell phone 4 similarly moves to this step S36.

When judging from the received BCH that the electronic equipment 6 is the registered electronic equipment 6, the cell phone 4 transmits the identification information ID such as IMEI and the password of the cell phone 4 to the cell phone communication module 10 with a RACH (step S37), judging whether any connection request has been made from the electronic equipment 6 with a FACH (step S38). In this case, we assume that the connection request with the RACH after the authentication processing is storage of the data of the cell phone 4. In the presence of a connection request from the electronic equipment 6, the cell phone 4 proceeds with the connection processing with the electronic equipment 6 using a FACH/RACH (step S39), establishing a DCH link (step S40).

On the other hand, the cell phone 4 judges whether the connection request (RACH) is data readout from the electronic equipment 6 (step S41), making a data transmission request with a DCH when the connection request is data readout from the electronic equipment 6 (step S42). The cell phone 4 judges whether all the requested data has been received error-free (step S43), returning to step S42 and requesting the data transmission again with a DCH if the data has not been perfectly received. When the requested data has been received error-free, the cell phone 4 judges whether an end cue has been received (step S44), displays the completion of the data reception on the screen of the display device 22 (step S45) and stores the received data to a given address of the data storage device 18 (step S46), completing the processing and returning to the initial step or step S31 after proceeding with the cutoff processing (step S47).

On the other hand, if, in step S41, the connection request is not data readout from the electronic equipment 6, the cell phone 4 judges whether a data transmission request has been made from the electronic equipment 6 (step S48), transmitting the requested data with a DCH (step S49). The cell phone 4 judges whether the transmission is complete (step S50) and whether an end cue has been received (step S51). When the end cue has been received, the cell phone 4 displays the completion of data storage on the screen of the display device 22 (step S52), proceeding with the cutoff processing (step S47), completing the processing and similarly returning to step S31, the initial step. On the other hand, even in the absence of a data transmission request from the electronic equipment 6 in step S48, the cell phone 4 proceeds with the cutoff processing (step S47), completes the processing and similarly returns to step S31, the initial step.

Features, modifications and others of the above-described embodiment are:

(1) As shown in the aforementioned embodiment, the electronic equipment 6 is equipped with the cell phone communication module 10 as a communication capability, with the broadcast information being transmitted using the cell phone communication module 10 and a W-CDMA radio wave, for example, as the communication system of the cell phone. The cell phone 4 automatically establishes direct connection with the electronic equipment 6 upon detecting the broadcast information. The electronic equipment 6 instructs the cell phone 4 to back up the stored data such as the phone book data, prepared documents and email data in advance, with the cell phone 4 automatically transmitting the registered data to the electronic equipment 6, thus implementing the backup of the transmitted data using the data storage capability of the electronic equipment 6. The backup data can be updated to the latest data by conducting the same processing. The data backed up in the electronic equipment 6 can be read out for access on the cell phone 4.

(2) In such a configuration, the existing communication capabilities of the electronic equipment 6 and the cell phone 4 can be used, eliminating the need for adding new devices and preventing increased cost and size. This is more advantageous than use of the Bluetooth module because no devices are added.

(3) The automatic backup processing of the data of the cell phone 4 saves time and effort for the backup operation, keeping the backup data, stored in the electronic equipment 6, updated to the latest data.

(4) The electronic equipment 6—the data storage destination—and the cell phone 4 are directly connected, requiring no involvement of a charging system and preventing occurrence of a communication charge.

(5) The reaching distance of the cell phone 4's transmission power is several km, thus allowing data backup with the electronic equipment 6, apart to a certain extent, by using the communication capability of the cell phone 4.

(6) As long as the cell phone 4 and the electronic equipment 6 are within a reachable distance of the radio wave of the cell phone, the data stored in the electronic equipment 6 can be read out into the cell phone 4 for referencing as desired, allowing to quickly address data loss, damage and other incidents of the cell phone 4.

(7) While in the above embodiment, description was given taking a personal computer for example as the electronic equipment 6, any piece of electronic equipment may be used as long as the equipment has the communication and data storage capabilities. The electronic equipment is not limited to the equipment illustrated in the above embodiment, and a terminal device may be used as with the cell phone 4. That is, data backup is possible between cell phones.

(8) While in the aforementioned embodiment, description was given taking the cell phone 4 for example as a terminal device, any one of terminal equipment equipped with the communication capability, including a personal computer, PDA, digital camera and watch, may be used as the terminal device for accumulating the data to be stored.

(9) While in the above embodiment, direct connection was established between the cell phone 4 and the electronic equipment 6 using the radio wave 8 in the mobile communications band with W-CDMA taken as an example of a communication method, the communication method is not limited to W-CDMA. On the other hand, any radio wave may be used as long as broadcast information exchange, direct connection and backup data exchange are possible, and any communication system may be used.

(10) While a HDD and a flash memory were taken for example as the data storage devices for the electronic equipment 6 and the cell phone 4, the data storage devices may be configured with a recording medium other than HDD or flash memory.

While the most preferred embodiment of the present invention has been described hereinabove, the present invention is not limited to the above description thereof, and it is a matter of course that various variations and modifications can be made by those skilled in the art within the scope of the claims without departing from the spirit of the invention disclosed herein, and needless to say, such variations and modifications are also encompassed in the scope of the present invention.

The entire disclosure of Japanese Patent Application No. 2004-202265 including specification, claims, drawings and summary are incorporated herein by reference in its entirety.

What is claimed is:

1. A terminal device comprising:
a communication unit connecting to electronic equipment having data storage and communication capabilities by use of the communication unit; and
a data processing unit driving the communication unit to transmit data to be stored to the electronic equipment, thereby allowing the electronic equipment to store the data.

2. The terminal device of claim 1, wherein at a given time interval the data processing unit monitors broadcast information transmitted from the electronic equipment.

3. The terminal device of claim 1, wherein the data processing unit drives the data to be stored to be transmitted to the electronic equipment based on identification of specific electronic equipment.

4. The terminal device of claim 1, wherein the electronic equipment periodically transmits broadcast information.

5. The terminal device of claim 1, wherein in cases where the electronic equipment stores data of the terminal device, the electronic equipment halts transmission of broadcast information until a given time elapses from the storage of the data.

6. A data backup system for a terminal device, arranged to back up data accumulated in the terminal device, comprising:
electronic equipment having data storage and communication capabilities; and
the terminal device including a communication unit connecting for communication to the electronic equipment by use of the communication capability and a data processing unit driving the communication unit to transmit data to be stored, thereby allowing the electronic equipment to store the data.

7. The data backup system for a terminal device of claim 6, wherein the data processing unit drives the data to be stored to be transmitted to the electronic equipment based on identification of specific electronic equipment.

8. The data backup system for a terminal device of claim 6, wherein the electronic equipment periodically transmits broadcast information.

9. The data backup system for a terminal device of claim 6, wherein in cases where the electronic equipment stores the data of the terminal device, the electronic equipment halts transmission of broadcast information until a given time elapses from completing the storage of the data.

10. A data backup method for a terminal device that backs up data accumulated in the terminal device, comprising:
a communication processing of connecting for communication to electronic equipment having data storage and communication capabilities using the communication unit; and
a data processing of driving data to be stored to be transmitted.

11. The data backup method for a terminal device of claim 10, wherein the data processing includes a processing of driving the data to be stored to be transmitted to the electronic equipment based on identification of specific electronic equipment.

12. The data backup method for a terminal device of claim 10, further comprising a processing of periodically transmitting broadcast information from the electronic equipment.

13. The data backup method for a terminal device of claim 10, further comprising a processing of halting transmission of broadcast information, in cases where the data of the terminal device is stored in the electronic equipment, until a given time elapses from completing the storage of the data.

14. A data backup program for a terminal device that backs up data accumulated in the terminal device, comprising the steps of:
driving the terminal device to connect to electronic equipment having data storage and communication capabilities by use of the communication unit; and
driving the terminal device to transmit data to be stored to the connected electronic equipment.

15. A data backup program for a terminal device that backs up data accumulated in the terminal device, comprising the steps of:
identifying the terminal device based on specific information registered in advance in electronic equipment where the data is to be stored; and
driving data transferred from the identified terminal device to be stored at a data storage location of the electronic equipment.

16. The data backup program for a terminal device of claim 15, wherein the data storage includes the step of driving the data to be stored to be transmitted to the electronic equipment based on identification of specific electronic equipment.

17. The data backup program for a terminal device of claim 14, further comprising the step of periodically transmitting broadcast information from the electronic equipment.

18. The data backup program for a terminal device of claim 15, further comprising the step of halting transmission of broadcast information, in cases where the data of the terminal device is stored, until a given time elapses from completing the storage of the data.
